(19) United States
(12) Patent Application Publication
(10) Pub. No.: US 2007/0077456 A1
(43) Pub. Date: Apr. 5, 2007

(54) Thermal spray coating

(76) Inventors: Junya Kitamura, Kakamigahara-shi (JP); Isao Aoki, Tajimi-shi (JP); Yoshikazu Sugiyama, Ichinomiya-shi (JP)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/540,011

(22) Filed: Sep. 29, 2006

(30) Foreign Application Priority Data
Sep. 30, 2005 (JP) 2005-289174
Sep. 30, 2005 (JP) 2005-289175

(51) Int. Cl. B32B 9/00

(52) U.S. Cl. 428/701; 428/702

(57) ABSTRACT

A thermal spray coating includes yttrium oxide at least as a main component. When the thermal spray coating is exposed to CF₄ plasma and the plasma power of the CF₄ plasma per unit area applied onto the thermal spray coating is 0.8 W/cm² or greater, an etching rate by the CF₄ plasma of the thermal spray coating satisfies the equation Re≦7.7×Pp^{2.2}. Alternatively, when the plasma power of the CF₄ plasma per unit area applied onto the thermal spray coating is less than 0.8 W/cm², an etching rate by the CF₄ plasma of the thermal spray coating satisfies the equation Re≦8.0×Pp^{2.2}. In the equations, “Re”, represents the etching rate (nm/minute) by the CF₄ plasma of the thermal spray coating, and “Pp” represents the plasma power per unit area (W/cm²) applied onto the thermal spray coating.

### BACKGROUND OF THE INVENTION

The present invention relates to a thermal spray coating which comprises yttrium oxide (yttria) at least as a main component.

In the field of producing semiconductor devices or liquid crystal devices, micro-fabrication of the devices is conducted by dry-etching using plasma. During this plasma process, some portions of the semiconductor device production equipment or liquid crystal device production apparatus may be liable to etching damage by the plasma. However, techniques are known (e.g. Japanese Laid-Open Patent Publication No. 2002-80954) for improving the plasma etching resistance of such portions by providing a thermal spray coating thereon. By improving plasma etching resistance in this manner, scattering of particles can be suppressed, and as a result, the device yield improves.

Thermal spray coatings which are used for this purpose can be formed by plasma-spraying a thermal spray powder comprising, for example, granulated and sintered yttria particles. Development has been attempted to enhance the plasma etching resistance of thermal spray coatings against different types of plasma, such as high-power plasma and low-power plasma. However, none of thermal spray coatings has satisfied yet performance requirements.

### SUMMARY OF THE INVENTION

Accordingly, a first objective of the present invention is to provide a thermal spray coating that has excellent plasma etching resistance against a plasma in which the plasma power applied to the thermal spray coating per unit surface area is no less than 0.8 W/cm² (in the present specification hereinafter referred to as “high-power plasma”). A second objective of the present invention is to provide a thermal spray coating that has excellent plasma etching resistance against a plasma in which the plasma power applied to the thermal spray coating per unit surface area is less than 0.8 W/cm² (in the present specification hereinafter referred to as “low-power plasma”).

To achieve the foregoing objectives and in accordance with a first aspect of the present invention, a thermal spray coating including yttrium oxide at least as a main component is provided. When the thermal spray coating is exposed to CF₄ plasma and the plasma power of the CF₄ plasma per unit area applied onto the thermal spray coating is 0.8 W/cm² or greater, an etching rate by the CF₄ plasma of the thermal spray coating satisfies the equation Re≦7.7×Pp^{2.2}. “Re” represents the etching rate (nm/minute) by the CF₄ plasma of the thermal spray coating, and “Pp” represents the plasma power per unit area (W/cm²) applied onto the thermal spray coating.

In accordance with a second aspect of the present invention, a thermal spray coating including yttrium oxide at least as a main component is provided. When the thermal spray coating is exposed to CF₄ plasma and the plasma power of the CF₄ plasma per unit area applied onto the thermal spray coating is less than 0.8 W/cm², an etching rate by the CF₄ plasma of the thermal spray coating satisfies the equation Re≦8.0×Pp^{2.2}. “Re” represents the etching rate (nm/minute) by the CF₄ plasma of the thermal spray coating, and “Pp” represents the plasma power per unit area (W/cm²) applied onto the thermal spray coating.

Other aspects and advantages of the invention will become apparent from the following description, illustrating by way of example the principles of the invention.

### DETAILED DESCRIPTION OF THE PREFERRED EMBODIMENTS

A first embodiment of the present invention will now be described.

It is necessary for the etching rate by CF₄ plasma of a thermal spray coating according to the first embodiment to satisfy the equation Re≦7.7×Pp^{2.2} when the plasma power per unit area applied onto the thermal spray coating is 0.8 W/cm² or greater. In this equation, “Re” represents the etching rate (nm/minute) by CF₄ plasma of a thermal spray coating, and “Pp” represents the plasma power per unit area (W/cm²) applied onto the thermal spray coating.

The thermal spray coating according to the first embodiment is formed by the thermal spraying of a thermal spray powder, and comprises yttria at least as a main component. The yttria content in the thermal spray coating is preferably no less than 90%, more preferably no less than 95%, and most preferably no less than 99%. While there are no limitations on the components other than yttria in the thermal spray coating, rare earth oxides are preferable.

The thermal spray powder which will serve as the forming material of the thermal spray coating may comprise granulated yttria particles, may comprise granulated and sintered yttria particles, or may comprise fused and crushed yttria particles. Granulated yttria particles are produced by granulating a yttria powder. Granulated and sintered yttria particles are produced by producing a granulated powder from a raw material powder, then sintering and crushing this granulated powder into smaller particles, and if necessary, classifying. Fused and crushed yttria particles are produced by fusing a raw material powder, cooling the fused powder to solidify, then crushing, and if necessary, classifying. The raw material powder for the granulated and sintered yttria particles or the fused and crushed yttria particles may be a yttria powder, or may be a powder of a substance which can ultimately be converted to yttria during the process of sintering or fusing, such as a yttrium powder, a yttrium hydroxide powder, and a mixture of a yttria powder with a yttrium powder or yttrium hydroxide powder.

If the average particle size of the thermal spray powder is less than 20 μm, a large quantity of comparatively fine particles may be contained in the thermal spray powder, whereby a thermal spray powder with good flowability may not be obtained. Therefore, to improve the flowability of the thermal spray powder, the average particle size of the thermal spray powder is preferably no less than 20 μm. It is noted that as flowability of the thermal spray powder is lower, the supply of thermal spray powder to the thermal spray flame tends to become more unstable, whereby the thermal spray coating thickness is more likely to be uneven and the plasma etching resistance of the thermal spray coating more likely to be uneven.

On the other hand, if the average particle size of the thermal spray powder exceeds 60 μm, it may be more difficult for the thermal spray powder to be sufficiently softened or melted by the thermal spray flame, whereby as a consequence the deposit efficiency (thermal spray yield) of the thermal spray powder may be lower and become uneconomic. Therefore, to improve the deposit efficiency, the average particle size of the thermal spray powder is preferably no greater than 60 μm.

In the case of the thermal spray powder comprising granulated and sintered yttria particles, if the average particle size of the primary particles constituting the granulated and sintered yttria particles is less than 0.5 μm, the plasma etching resistance of the thermal spray coating against high-power plasma may be slightly lower. The reason for this is that as the average particle size of the primary particles constituting the granulated and sintered yttria particles becomes smaller, the inter-lamellar region in the thermal spray coating which exhibits a lamellar structure relatively increases. The inter-lamellar region contains a large number of crystal defects, and since etching of the thermal spray coating by the plasma preferentially proceeds from defective portions in the thermal spray coating, a thermal spray coating having a higher relative volume of inter-lamellar region tends to have a lower plasma etching resistance against high-power plasma. Therefore, from the perspective of improving plasma etching resistance of the thermal spray coating against high-power plasma, the average particle size of the primary particles constituting the granulated and sintered yttria particles is preferably 0.5 μm or greater.

On the other hand, also if the average particle size of the primary particles constituting the granulated and sintered yttria particles exceeds 1.5 μm, the plasma etching resistance of the thermal spray coating against high-power plasma may be slightly lower. The reason for this is that as the average particle size of the primary particles constituting the granulated and sintered yttria particles becomes larger, the thickness of the inter-lamellar region in the thermal spray coating increases. As described above, the inter-lamellar region contains a large number of crystal defects, and since etching of the thermal spray coating by the plasma preferentially proceeds from defective portions in the thermal spray coating, a thermal spray coating which comprises an inter-lamellar region having a larger thickness tends to have a lower plasma etching resistance against high-power plasma. Therefore, from the perspective of improving plasma etching resistance of the thermal spray coating against high-power plasma, the average particle size of the primary particles constituting the granulated and sintered yttria particles is preferably no greater than 1.5 μm.

The method of spraying the thermal spray powder used to form the thermal spray coating may be plasma spraying, or may be some other thermal spraying process. However, the ambient pressure during plasma spraying of the thermal spray powder is preferably atmospheric pressure. Stated another way, the thermal spray coating is preferably formed by atmospheric-pressure plasma spraying of a thermal spray powder. If the ambient pressure during plasma spraying is not atmospheric pressure, and especially in the case of a low pressure atmosphere (reduced pressure atmosphere), the plasma etching resistance of the thermal spray coating against high-power plasma may be slightly lower. The reason for this is that if the thermal spray powder is plasma sprayed under a low pressure, reduction of the yttria in the thermal spray powder may occur during the thermal spraying, whereby as a consequence lattice defects due to oxygen deficiency may be more likely to be contained in the thermal spray coating. As described above, since etching of the thermal spray coating by the plasma preferentially proceeds from defective portions in the thermal spray coating, there is a tendency for a thermal spray coating formed by low pressure plasma spraying to have worse plasma etching resistance against high-power plasma than that for a thermal spray coating formed by atmospheric-pressure plasma spraying.

If the porosity of the thermal spray coating exceeds 15%, more specifically exceeds 12%, and even more specifically exceeds 10%, plasma etching resistance of the thermal spray coating against high-power plasma may be slightly lower. The reason for this is that etching of the thermal spray coating by the plasma preferentially proceeds from the pore vicinity in the thermal spray coating. Further, if porosity of the thermal spray coating is within the above-described range, through-holes may be contained in the thermal spray coating. As a consequence, etching damage of the substrate due to the plasma may not be sufficiently prevented. Therefore, from the perspectives of improving the plasma etching resistance of the thermal spray coating against high-power plasma and of preventing through-holes, the porosity of the thermal spray coating is preferably no greater than 15%, more preferably no greater than 12%, and most preferably no greater than 10%.

On the other hand, if the porosity of the thermal spray coating is less than 1%, more specifically less than 2%, and even more specifically less than 3%, the thermal spray coating is too dense, whereby the thermal spray coating may become more susceptible to peeling from residual stress in the thermal spray coating. Therefore, the porosity of the thermal spray coating is preferably 1% or greater, more preferably 2% or greater, and most preferably 3% or greater.

If the thickness of the thermal spray coating is less than 50 μm, and more specifically less than 100 μm, through-holes may be contained in the thermal spray coating, whereby etching damage of the substrate due to the plasma may not be sufficiently prevented. Therefore, to prevent through-holes, the thickness of the thermal spray coating is preferably no less than 50 μm, and more preferably no less than 100 μm.

On the other hand, if the thickness of the thermal spray coating exceeds 1,000 μm, and more specifically exceeds 800 μm, the thermal spray coating may become more susceptible to peeling from residual stress in the thermal spray coating. Therefore, to prevent peeling of the thermal spray coating, the thickness of the thermal spray coating is preferably no greater than 1,000 μm, and more preferably no greater than 800 μm.

If the size of the crystallites in the thermal spray coating is less than 10 nm, and more specifically is less than 15 nm, the plasma etching resistance of the thermal spray coating against high-power plasma may be slightly lower. The reason for this is that as the size of the crystallites in the thermal spray coating becomes smaller, the grain boundary density in the thermal spray coating increases. Since etching of the thermal spray coating by high-power plasma preferentially proceeds from the grain boundary, a thermal spray coating having a high grain boundary density will tend to have a worse plasma etching resistance against high-power plasma. Therefore, from the perspective of improving the plasma etching resistance of the thermal spray coating against high-power plasma, the size of the crystallites in the thermal spray coating is preferably no less than 10 nm, and more preferably no less than 15 nm.

On the other hand, also if the size of the crystallites in the thermal spray coating exceeds 50 nm, and more specifically exceeds 40 nm, the plasma etching resistance of the thermal spray coating against high-power plasma may be slightly lower. The reason for this is that the fact that the size of the crystallites is large means that a large quantity of unmelted thermal spray powder is mixed in the thermal spray coating. Since etching of the thermal spray coating by the plasma also preferentially proceeds from portions of the thermal spray powder which are unmelted in the thermal spray coating, a thermal spray coating which contains a large quantity of unmelted thermal spray powder will tend to have worse plasma etching resistance against high-power plasma. Therefore, from the perspective of improving the plasma etching resistance of the thermal spray coating against high-power plasma, the size of the crystallites in the thermal spray coating is preferably no greater than 50 nm, and more preferably no greater than 40 nm.

If the Vickers microhardness of the thermal spray coating is less than 300, and more specifically is less than 350, the wear resistance of the thermal spray coating may be lower. Therefore, to improve the wear resistance of the thermal spray coating, the Vickers microhardness of the thermal spray coating is preferably no less than 300, and more preferably no less than 350.

On the other hand, if the Vickers microhardness of the thermal spray coating exceeds 600, and more specifically exceeds 550, the impact resistance of the thermal spray coating may be lower. Therefore, to improve the impact resistance of the thermal spray coating, the Vickers microhardness of the thermal spray coating is preferably no greater than 600, and more preferably no greater than 550.

When the thermal spray coating is subjected to the same wear test as that of a carbon steel (rolled steel for general structure) SS400, if the ratio of the thermal spray coating wear volume with respect to the carbon steel SS400 wear volume exceeds 3, more specifically exceeds 2.7, and still more specifically exceeds 2.5, the wear resistance of the thermal spray coating may be insufficient for practical use. Therefore, to ensure sufficient wear resistance for practical use, the ratio of the thermal spray coating wear volume with respect to the carbon steel SS400 wear volume is preferably no greater than 3, more preferably no greater than 2.7, and most preferably no greater than 2.5.

A second embodiment of the present invention will now be described.

It is necessary for the etching rate by CF₄ plasma of a thermal spray coating according to the second embodiment to satisfy the equation Re≦8.0×Pp^{2.2} when the plasma power per unit area applied onto the thermal spray coating is less than 0.8 W/cm². In this equation, “Re” represents the etching rate (nm/minute) by CF₄ plasma of a thermal spray coating, and “Pp” represents the plasma power per unit area (W/cm²) applied onto the thermal spray coating.

The thermal spray coating according to the second embodiment is formed by the thermal spraying of a thermal spray powder, and comprises yttria at least as a main component. The yttria content in the thermal spray coating is preferably no less than 90%, more preferably no less than 95%, and most preferably no less than 99%. While there are no limitations on the components other than yttria in the thermal spray coating, rare earth oxides are preferable.

The thermal spray powder which will serve as the forming material of the thermal spray coating may comprise granulated yttria particles, may comprise granulated and sintered yttria particles, or may comprise fused and crushed yttria particles. Granulated yttria particles are produced by granulating a yttria powder. Granulated and sintered yttria particles are produced by producing a granulated powder from a raw material powder, then sintering and crushing this granulated powder into smaller particles, and if necessary, classifying. Fused and crushed yttria particles are produced by fusing a raw material powder, cooling the fused powder to solidify, then crushing, and if necessary, classifying. The raw material powder for the granulated and sintered yttria particles or the fused and crushed yttria particles may be a yttria powder, or may be a powder of a substance which can ultimately be converted to yttria during the process of sintering or fusing, such as a yttrium powder, a yttrium hydroxide powder, and a mixture of a yttria powder with a yttrium powder or yttrium hydroxide powder.

If the average particle size of the thermal spray powder is less than 20 μm, a large quantity of comparatively fine particles may be contained in the thermal spray powder, whereby a thermal spray powder with good flowability may not be obtained. Therefore, to improve the flowability of the thermal spray powder, the average particle size of the thermal spray powder is preferably no less than 20 μm. As flowability of the thermal spray powder decreases, the supply of thermal spray powder to the thermal spray flame tends to become more unstable, whereby as a consequence the thermal spray coating thickness is more likely to be uneven and the plasma etching resistance of the thermal spray coating more likely to be uneven.

On the other hand, if the average particle size of the thermal spray powder exceeds 60 μm, it may be more difficult for the thermal spray powder to be sufficiently softened or melted by the thermal spray flame, whereby as a consequence, the deposit efficiency (thermal spray yield) of the thermal spray powder may be lower and become uneconomic. Therefore, to improve the deposit efficiency, the average particle size of the thermal spray powder is preferably no greater than 60 μm.

In the case of the thermal spray powder comprising granulated and sintered yttria particles, if the average particle size of the primary particles constituting the granulated and sintered yttria particles is less than 3 μm, the plasma etching resistance of the thermal spray coating against low-power plasma may be slightly lower. The reason for this is that as the average particle size of the primary particles constituting the granulated and sintered yttria particles becomes smaller, the inter-lamellar region in the thermal spray coating having a lamellar structure increases relatively. The inter-lamellar region contains a large number of crystal defects, and since etching of the thermal spray coating by the plasma preferentially proceeds from defective portions in the thermal spray coating, a thermal spray coating having a higher relative volume of inter-lamellar region tends to have a lower plasma etching resistance against low-power plasma. Therefore, from the perspective of improving plasma etching resistance of the thermal spray coating against low-power plasma, the average particle size of the primary particles constituting the granulated and sintered yttria particles is preferably no less than 3 μm.

On the other hand, also if the average particle size of the primary particles constituting the granulated and sintered yttria particles exceeds 8 μm, the plasma etching resistance of the thermal spray coating against low-power plasma may be slightly lower. The reason for this is that as the average particle size of the primary particles constituting the granulated and sintered yttria particles becomes larger, the thickness of the inter-lamellar region in the thermal spray coating increases. As described above, the inter-lamellar region contains a large number of crystal defects, and since etching of the thermal spray coating by the plasma preferentially proceeds from defective portions in the thermal spray coating, a thermal spray coating which comprises an inter-lamellar region having a large thickness tends to have a lower plasma etching resistance against low-power plasma. Therefore, from the perspective of improving plasma etching resistance of the thermal spray coating against low-power plasma, the average particle size of the primary particles constituting the granulated and sintered yttria particles is preferably no greater than 8 μm.

The method of spraying the thermal spray powder used to form the thermal spray coating may be plasma spraying, or may be some other thermal spraying process. The ambient pressure during plasma spraying of the thermal spray powder is preferably atmospheric pressure. In other words, the thermal spray coating is preferably formed by atmospheric-pressure plasma spraying of a thermal spray powder. If the ambient pressure during plasma spraying is not atmospheric pressure, and especially in the case of a low pressure atmosphere, the plasma etching resistance of the thermal spray coating against low-power plasma may be slightly lower. That is because if the thermal spray powder is plasma sprayed under a low pressure, reduction of the yttria in the thermal spray powder may occur during the thermal spraying, whereby as a consequence lattice defects due to oxygen deficiency may be more likely to be contained in the thermal spray coating. As described above, since etching of the thermal spray coating by the plasma preferentially proceeds from defective portions in the thermal spray coating, there is a tendency for a thermal spray coating formed by low pressure plasma spraying to have worse plasma etching resistance against low-power plasma than that for a thermal spray coating formed by atmospheric-pressure plasma spraying.

If the porosity of the thermal spray coating exceeds 17%, more specifically exceeds 15%, and even more specifically exceeds 10%, the plasma etching resistance of the thermal spray coating against low-power plasma may be slightly lower. The reason for this is that etching of the thermal spray coating by the plasma preferentially proceeds from the pore vicinity in the thermal spray coating. Further, if porosity of the thermal spray coating is within the above-described range, through-holes may be contained in the thermal spray coating. As a consequence, there is a risk that etching damage of the substrate due to the plasma cannot be sufficiently prevented. Therefore, from the perspectives of improving the plasma etching resistance of the thermal spray coating against low-power plasma and of preventing through-holes, the porosity of the thermal spray coating is preferably no greater than 17%, more preferably no greater than 15%, and still more preferably no greater than 10%.

On the other hand, if the porosity of the thermal spray coating is less than 2%, more specifically less than 3%, and even more specifically less than 5%, the thermal spray coating is too dense, whereby the thermal spray coating may become more susceptible to peeling from residual stress in the thermal spray coating. Therefore, the porosity of the thermal spray coating is preferably 2% or greater, more preferably 3% or greater, and most preferably 5% or greater.

If the thickness of the thermal spray coating is less than 50 μm, and more specifically less than 100 μm, through-holes may be contained in the thermal spray coating, whereby etching damage of the substrate due to the plasma may not be sufficiently prevented. Therefore, to prevent through-holes, the thickness of the thermal spray coating is preferably no less than 50 μm, and more preferably no less than 100 μm.

On the other hand, if the thickness of the thermal spray coating exceeds 1,000 μm, and more specifically exceeds 800 μm, the thermal spray coating may become more susceptible to peeling from residual stress in the thermal spray coating. Therefore, to prevent peeling of the thermal spray coating, the thickness of the thermal spray coating is preferably no greater than 1,000 μm, and more preferably no greater than 800 μm.

If the size of the crystallites in the thermal spray coating is less than 20 nm, the plasma etching resistance of the thermal spray coating against low-power plasma may be slightly lower. The reason for this is that as the size of the crystallites in the thermal spray coating becomes smaller, the grain boundary density in the thermal spray coating increases. Since etching of the thermal spray coating by low-power plasma preferentially proceeds from the grain boundary, a thermal spray coating having a high grain boundary density will tend to have a worse plasma etching resistance against low-power plasma. Therefore, from the perspective of improving the plasma etching resistance of the thermal spray coating against low-power plasma, the size of the crystallites in the thermal spray coating is preferably no less than 20 nm.

On the other hand, also if the size of the crystallites in the thermal spray coating exceeds 80 nm, the plasma etching resistance of the thermal spray coating against low-power plasma may be slightly lower. The reason for this is that the fact that the size of the crystallites is large means that a large quantity of unmelted thermal spray powder is mixed in the thermal spray coating. Since etching of the thermal spray coating by the plasma also preferentially proceeds from portions of the thermal spray powder which are unmelted in the thermal spray coating, a thermal spray coating which contains a large quantity of unmelted thermal spray powder will tend to have worse plasma etching resistance against low-power plasma. Therefore, from the perspective of improving the plasma etching resistance of the thermal spray coating against low-power plasma, the size of the crystallites in the thermal spray coating is preferably no greater than 80 nm.

If the Vickers microhardness of the thermal spray coating is less than 300, the wear resistance of the thermal spray coating may be lower. Therefore, to improve the wear resistance of the thermal spray coating, the Vickers microhardness of the thermal spray coating is preferably no less than 300.

On the other hand, if the Vickers microhardness of the thermal spray coating exceeds 700, the impact resistance of the thermal spray coating may be lower. Therefore, to improve the impact resistance of the thermal spray coating, the Vickers microhardness of the thermal spray coating is preferably no greater than 700.

When the thermal spray coating is subjected to the same wear test as that of a carbon steel (rolled steel for general structure) SS400, if the ratio of the thermal spray coating wear volume with respect to the carbon steel SS400 wear volume exceeds 2.5, the wear resistance of the thermal spray coating may be insufficient for practical use. Therefore, to ensure sufficient wear resistance for practical use, the ratio of the thermal spray coating wear volume with respect to the carbon steel SS400 wear volume is preferably no greater than 2.5.

The first embodiment and the second embodiment may be modified in the following manner.

The thermal spray coatings according to the first and second embodiments may respectively be formed by thermal spraying a thermal spray material which is not in powdered form in place of the thermal spray powder.

Next, the Examples and Comparative Examples for the first embodiment will be explained.

The thermal spray coatings of Examples 1 to 11 and Comparative Examples 1 and 2 were formed by plasma spraying thermal spray powders consisting of granulated yttria particles, granulated and sintered yttria particles, or fused and crushed yttria particles. Details of the respective thermal spray coatings and the thermal spray powders used when forming those thermal spray coatings are as illustrated in Table 1. The thermal spray conditions when forming the thermal spray coatings (atmospheric-pressure plasma spraying conditions and low pressure plasma spraying conditions) are as illustrated in Table 2.

The column entitled “Etching rate” in Table 1 represents results of a measurement of the thermal spray coating etching rate by CF₄ plasma when the respective thermal spray coatings were exposed to CF₄ plasma whose plasma power (Pp) per unit area applied onto the thermal spray coating was 1 W/cm² (7.7×Pp^{2.2}=7.7), 2 W/cm² (7.7×Pp^{2.2}=35.4) or 3 W/cm² (7.7×Pp^{2.2}=86.3) Specifically, first, the surface of each thermal spray coating was mirror polished using colloidal silica having an average particle size of 0.06 μm. A portion of the surface of the polished thermal spray coatings was then masked with polyimide tape, after which the entire surface of the subject thermal spray coatings was subjected to plasma etching under the conditions illustrated in Table 3. The size of the step between the masked portion and the unmasked portion was then measured using the profiler “Alpha Step” manufactured by KLA-Tencor Corporation.

The column entitled “Porosity” in Table 1 represents results of a measurement of the porosity of each thermal spray coating. Specifically, first, each thermal spray coating was cut along a plane perpendicular to its upper surface. After the cut surface was mirror polished using colloidal silica having an average particle size of 0.06 μm, the porosity of the thermal spray coating at the cut surface was measured using the image analysis processor “NSFJ1-A” manufactured by N Support Corporation.

The column entitled “Thickness” in Table 1 represents results of a measurement of the thickness of each thermal spray coating. Specifically, first, each thermal spray coating was cut along a plane perpendicular to its upper surface. After the cut surface was mirror polished using colloidal silica having an average particle size of 0.06 μm, the thickness of the thermal spray coating at the cut surface was measured using an optical microscope.

The column entitled “Crystallite size” in Table 1 represents results of a measurement of the size of the crystallites in each thermal spray coating. Specifically, the size of the crystallites was measured according to the Hall method from the X-ray diffraction pattern for each thermal spray coating as measured using the X-ray diffractometer “RINT-2000” manufactured by Rigaku Corporation.

The column entitled “Vickers hardness” in Table 1 represents results of a measurement of the Vickers microhardness of each thermal spray coating.

The column entitled “Wear ratio” in Table 1 represents results of a measurement of the ratio of the thermal spray coating wear volume from an abrasive wheel wear test with respect to the carbon steel SS400 wear volume from the same abrasive wheel wear test. Specifically, the surface of a test sample was rubbed 400 times at a load of 2.00 kgf (approximately 19.6 N) with the abrasive paper CP240 as defined in JIS R6252.

The column entitled “Thermal spraying atmosphere” in Table 1 represents the ambient pressure during plasma spraying of each of the thermal spray powders for forming the thermal spray coatings.

The column entitled “Kind of thermal spray powder” in Table 1 represents whether each thermal spray powder consists of granulated yttria particles, granulated and sintered yttria particles, or fused and crushed yttria particles.

The column entitled “Average particle size of the thermal spray powder” in Table 1 represents the average particle size of the granulated yttria particles, granulated and sintered yttria particles, or fused and crushed yttria particles for each thermal spraying powder, as measured using a laser diffraction/dispersion type of particle size distribution measuring instrument “LA-300” manufactured by Horiba Ltd.

The column entitled “Average particle size of the primary particles constituting the granulated particles or granulated and sintered particles” in Table 1 represents the average particle size of the primary particles constituting the granulated yttria particles or granulated and sintered yttria particles of Examples 1 to 6 and 8 to 11, and Comparative Examples 1 and 2, measured using a field-emission scanning electron microscope (FE-SEM). Specifically, this represents the mean of oriented diameters (Feret's diameter) found by randomly selecting 10 granulated yttria particles or granulated and sintered yttria particles from each thermal spray powder, then randomly selecting 50 primary particles from each of the 10 selected granulated yttria particles or granulated and sintered yttria particles, and measuring a total of 500 primary particles for each thermal spray powder. The “oriented diameter” is the distance between two imaginary lines that sandwich and extend parallel from a particle.

TABLE 1

| | | | | | | | | | | | | Average particle |
|---|---|---|---|---|---|---|---|---|---|---|---|---|
| | | | | | | | | | | | Average | size of the |
| | | | | | | | | | | | particle | primary particles |
| | | | | | | | | | | | size | constituting |
| | | | | | | | | | | | of the | the granulated |
| | Etching rate | | | | | | | | | Kind of | thermal | particles or |
| | (nm/minute) | | | | Thick- | Crystal- | | | Thermal | thermal | spray | granulated and |
| | Pp = 1 | Pp = 2 | Pp = 3 | Porosity | ness | lite size | Vickers | Wear | spraying | spray | powder | sintered particles |
| | W/cm² | W/cm² | W/cm² | (%) | (μm) | (nm) | hardness | ratio | atmosphere | powder | (μm) | (μm) |
| Ex. 1 | 7.5 | 32.0 | 75.0 | 7 | 200 | 20 | 400 | 2.1 | atmospheric | granulated | 38.0 | 1.2 |
| | | | | | | | | | pressure | and sintered | | |
| Ex. 2 | 7.0 | 31.0 | 70.0 | 6 | 200 | 20 | 400 | 2.2 | atmospheric | granulated | 41.0 | 1.0 |
| | | | | | | | | | pressure | and sintered | | |
| Ex. 3 | 6.6 | 28.0 | 68.0 | 4 | 200 | 20 | 410 | 2.3 | atmospheric | granulated | 21.0 | 1.1 |
| | | | | | | | | | pressure | and sintered | | |
| C. Ex. | 8.0 | 36.0 | 89.0 | 5 | 200 | 25 | 420 | 2.3 | atmospheric | granulated | 29.0 | 1.8 |
| 1 | | | | | | | | | pressure | and sintered | | |
| C. Ex. | 8.0 | 38.0 | 94.0 | 8 | 200 | 32 | 440 | 2.1 | atmospheric | granulated | 41.0 | 5.2 |
| 2 | | | | | | | | | pressure | and sintered | | |
| Ex. 4 | 7.6 | 33.0 | 78.0 | 7 | 60 | 20 | 400 | 2.1 | atmospheric | granulated | 38.0 | 1.2 |
| | | | | | | | | | pressure | and sintered | | |
| Ex. 5 | 7.5 | 31.0 | 72.0 | 7 | 900 | 20 | 400 | 2.1 | atmospheric | granulated | 38.0 | 1.2 |
| | | | | | | | | | pressure | and sintered | | |
| Ex. 6 | 7.6 | 34.0 | 82.0 | 6 | 200 | 12 | 420 | 2.5 | atmospheric | granulated | 36.0 | 0.6 |
| | | | | | | | | | pressure | | | |
| Ex. 7 | 7.4 | 32.0 | 77.0 | 11 | 200 | 38 | 440 | 1.9 | atmospheric | fused and | 31.0 | — |
| | | | | | | | | | pressure | crushed | | |
| Ex. 8 | 7.5 | 34.0 | 81.0 | 8 | 200 | 7 | 390 | 2.4 | atmospheric | granulated | 41.0 | 0.1 |
| | | | | | | | | | pressure | | | |
| Ex. 9 | 7.4 | 33.0 | 79.0 | 6 | 200 | 25 | 400 | 2.1 | low pressure | granulated | 38.0 | 1.2 |
| | | | | | | | | | (0.6 atm) | and sintered | | |
| Ex. 10 | 7.6 | 31.0 | 78.0 | 7 | 40 | 20 | 400 | 2.1 | atmospheric | granulated | 38.0 | 1.2 |
| | | | | | | | | | pressure | and sintered | | |
| Ex. 11 | 7.5 | 33.0 | 79.0 | 12 | 1200 | 20 | 400 | 2.1 | atmospheric | granulated | 38.0 | 1.2 |
| | | | | | | | | | pressure | and sintered | | |

TABLE 2
Atmospheric-Pressure Plasma Spraying Conditions
Substrate: An aluminum alloy (A6061) sheet (50 mm × 75 mm × 5 mm)
which had been blast treated using a brown alumina abrasive (A#40)
Spray gun: “SG-100” manufactured by Praxair
Powder feeder: “Model 1264” manufactured by Praxair
Ar gas pressure: 50 psi (0.34 MPa)
He gas pressure: 50 psi (0.34 MPa)
Voltage: 37.0 V
Current: 900 A
Thermal spraying distance: 120 mm
Thermal spray powder feed amount: 20 g per minute
Low Pressure Plasma Spraying Conditions
Substrate: An aluminum alloy (A6061) sheet (50 mm × 75 mm × 5 mm)
which had been blast treated using a brown alumina abrasive (A#40)
Spray gun: “F4” manufactured by Sulzer-Metco
Powder feeder: “Twin 10” manufactured by Sulzer-Metco
Ar gas flow rate: 42 L/min
He gas pressure: 10 L/min
Voltage: 43.0 V
Current: 620 A
Thermal spraying distance: 200 mm
Thermal spray powder feed amount: 20 g per minute

TABLE 3

Etching apparatus: Reactive ion etching apparatus “NLD-800”
manufactured by Ulvac Inc.
Etching gas: CF₄
Etching gas flow rate: 0.054 L/min
Chamber pressure: 1 Pa
Etching time: 1 hour

As illustrated in Table 1, a meaningful difference between the thermal spray coatings of Examples 1 to 11 and the thermal spray coatings of Comparative Examples 1 and 2 was confirmed for an etching rate by high-power CF₄ plasma in which the plasma power per unit area applied onto a thermal spray coating was 1 W/cm², 2 W/cm², or 3 W/cm².

Next, the Examples and Comparative Examples for the second embodiment will be explained.

The thermal spray coatings of Examples 101 to 109 and Comparative Example 101 were formed by plasma spraying thermal spray powders consisting of granulated and sintered yttria particles or fused and crushed yttria particles. Details of the respective thermal spray coatings and the thermal spray powders used when forming those thermal spray coatings are as illustrated in Table 4. The thermal spraying conditions when forming the thermal spray coatings (atmospheric-pressure plasma spraying conditions and low pressure plasma spraying conditions) are as illustrated in Table 5.

The column entitled “Etching rate” in Table 4 represents results of a measurement of the thermal spray coating etching rate by CF₄ plasma when the respective thermal spray coatings were exposed to CF₄ plasma whose plasma power (Pp) per unit area applied onto the thermal spray coating was 0.2 W/cm² (8.0×Pp^{2.2}=0.23) or 0.7 W/cm² (8.0×Pp^{2.2}=3.7). Specifically, first, the surface of each thermal spray coating was mirror polished using colloidal silica having an average particle size of 0.06 μm. A portion of the surface of the polished thermal spray coatings was then masked with polyimide tape, after which the entire surface of the subject thermal spray coatings was subjected to plasma etching under the conditions illustrated in Table 6. The size of the step between the masked portion and the unmasked portion was then measured using the profiler “Alpha Step” manufactured by KLA-Tencor Corporation.

The column entitled “Porosity” in Table 4 represents results of a measurement of the porosity of each thermal spray coating. Specifically, first, each thermal spray coating was cut along a plane perpendicular to its upper surface. After the cut surface was mirror polished using colloidal silica having an average particle size of 0.06 μm, the porosity of the thermal spray coating at the cut surface was measured using an image analysis processor “NSFJ1-A” manufactured by N Support Corporation.

The column entitled “Thickness” in Table 4 represents results of a measurement of the thickness of each thermal spray coating. Specifically, first, each thermal spray coating was cut along a plane perpendicular to its upper surface. After the cut surface was mirror polished using colloidal silica having an average particle size of 0.06 μm, the thickness of the thermal spray coating at the cut surface was measured using an optical microscope.

The column entitled “Crystallite size” in Table 4 represents results of a measurement of the size of the crystallites in each thermal spray coating. Specifically, the size of the crystallites was measured according to the Hall method from the X-ray diffraction pattern for each thermal spray coating as measured using the X-ray diffractometer “RINT-2000” manufactured by Rigaku Corporation.

The column entitled “Vickers hardness” in Table 4 represents results of a measurement of the Vickers microhardness for each thermal spray coating.

The column entitled “Wear ratio” in Table 4 represents results of a measurement of the ratio of the thermal spray coating wear volume from an abrasive wheel wear test with respect to the carbon steel SS400 wear volume from the same abrasive wheel wear test. Specifically, the surface of a test sample was rubbed 400 times at a load of 2.00 kgf (approximately 19.6 N) with the abrasive paper CP240 as defined in JIS R6252.

The column entitled “Thermal spraying atmosphere” in Table 4 represents the ambient pressure during plasma spraying of each of the thermal spray powders for forming the thermal spray coatings.

The column entitled “Kind of thermal spray powder” in Table 4 represents whether each thermal spray powder consists of either granulated and sintered yttria particles or fused and crushed yttria particles.

The column entitled “Average particle size of the thermal spray powder” in Table 4 represents the average particle size of the granulated and sintered yttria particles or fused and crushed yttria particles for each of the thermal spray powders, which was measured using a laser diffraction/dispersion type of particle size distribution measuring instrument “LA-300”, manufactured by Horiba Ltd.

The column entitled “Average particle size of the primary particles constituting the granulated and sintered particles” in Table 4 represents the average particle size of the primary particles constituting the granulated and sintered yttria particles for each of the thermal spray powders of Examples 101, 102, 104 to 109, and Comparative Example 101, which was measured using a field-emission scanning electron microscope (FE-SEM). Specifically, this represents the mean of oriented diameters (Feret's diameter) found by randomly selecting 10 granulated and sintered yttria particles from each thermal spray powder, then randomly selecting 50 primary particles from each of the 10 randomly selected granulated and sintered yttria particles, and measuring the total of 500 primary particles for the each thermal spray powder. The “oriented diameter” is the distance between two imaginary lines that sandwich and extend parallel from a particle.

TABLE 4

| | | | | | | | | | | Average | |
|---|---|---|---|---|---|---|---|---|---|---|---|
| | | | | | | | | | | particle | Average particle |
| | | | | | | | | | | size | size of the |
| | | | | | | | | | | of the | primary particles |
| | Etching rate | | | | | | | | Kind of | thermal | constituting |
| | (nm/minute) | | | Thick- | Crystal- | | | Thermal | thermal | spray | the granulated |
| | Pp = 0.2 | Pp = 0.7 | Porosity | ness | lite size | Vickers | Wear | spraying | spray | powder | and sintered |
| | W/cm² | W/cm² | (%) | (μm) | (nm) | hardness | ratio | atmosphere | powder | (μm) | particles (μm) |
| Ex. 101 | 0.22 | 3.6 | 8 | 200 | 35 | 410 | 2.4 | atmospheric | granulated | 33.0 | 2.9 |
| | | | | | | | | pressure | and sintered | | |
| Ex. 102 | 0.19 | 3.2 | 8 | 200 | 48 | 440 | 2.1 | atmospheric | granulated | 41.0 | 6.1 |
| | | | | | | | | pressure | and sintered | | |
| C. Ex. | 0.24 | 4.0 | 7 | 200 | 25 | 420 | 2.2 | atmospheric | granulated | 39.0 | 1.2 |
| 101 | | | | | | | | pressure | and sintered | | |
| Ex. 103 | 0.21 | 3.6 | 11 | 200 | 46 | 430 | 1.9 | atmospheric | fused and | 33.0 | — |
| | | | | | | | | pressure | crushed | | |
| Ex. 104 | 0.20 | 3.3 | 9 | 60 | 48 | 440 | 2.1 | atmospheric | granulated | 41.0 | 6.1 |
| | | | | | | | | pressure | and sintered | | |
| Ex. 105 | 0.20 | 3.4 | 11 | 900 | 48 | 440 | 2.1 | atmospheric | granulated | 41.0 | 6.1 |
| | | | | | | | | pressure | and sintered | | |
| Ex. 106 | 0.22 | 3.4 | 8 | 40 | 48 | 440 | 2.1 | atmospheric | granulated | 41.0 | 6.1 |
| | | | | | | | | pressure | and sintered | | |
| Ex. 107 | 0.22 | 3.4 | 13 | 1200 | 48 | 440 | 2.1 | atmospheric | granulated | 41.0 | 6.1 |
| | | | | | | | | pressure | and sintered | | |
| Ex. 108 | 0.18 | 3.0 | 9 | 250 | 44 | 420 | 2.0 | atmospheric | granulated | 32.0 | 8.0 |
| | | | | | | | | pressure | and sintered | | |
| Ex. 109 | 0.21 | 3.4 | 7 | 200 | 44 | 460 | 2.0 | low pressure | granulated | 41.0 | 6.1 |
| | | | | | | | | (0.6 atm) | and sintered | | |

TABLE 5
Atmospheric-Pressure Plasma Spraying Conditions
Substrate: An aluminum alloy (A6061) sheet (50 mm × 75 mm × 5 mm)
which had been blast treated using a brown alumina abrasive (A#40)
Spray gun: “SG-100” manufactured by Praxair
Powder feeder: “Model 1264” manufactured by Praxair
Ar gas pressure: 50 psi (0.34 MPa)
He gas pressure: 50 psi (0.34 MPa)
Voltage: 37.0 V
Current: 900 A
Thermal spraying distance: 120 mm
Thermal spray powder feed amount: 20 g per minute
Low Pressure Plasma Spraying Conditions
Substrate: An aluminum alloy (A6061) sheet (50 mm × 75 mm × 5 mm)
which had been blast treated using a brown alumina abrasive (A#40)
Spray gun: “F4” manufactured by Sulzer-Metco
Powder feeder: “Twin 10” manufactured by Sulzer-Metco
Ar gas flow rate: 42 L/min
He gas flow rate: 10 L/min
Voltage: 43.0 V
Current: 620 A
Thermal spraying distance: 200 mm
Thermal spray powder feed amount: 20 g per minute

TABLE 6

Etching apparatus: reactive ion etching apparatus “RIE-200”
manufactured by Samco Inc.
Etching gas: CF₄
Etching gas flow rate: 0.054 L/min
Chamber pressure: 5 Pa
Etching time: 8 hours

As illustrated in Table 4, a meaningful difference between the thermal spray coating of Examples 101 to 109 and the thermal spray coating of Comparative Example 101 was confirmed for an etching rate by low-power CF₄ plasma in which the plasma power per unit area applied onto a thermal spray coating was 0.2 W/cm² or 0.7 W/cm².

1. A thermal spray coating comprising yttrium oxide at least as a main component, wherein, when the thermal spray coating is exposed to CF₄ plasma and the plasma power of the CF₄ plasma per unit area applied onto the thermal spray coating is 0.8 W/cm² or greater, an etching rate by the CF₄ plasma of the thermal spray coating satisfies the equation Re≦7.7×Pp^{2.2}, “Re” representing the etching rate (nm/minute) by the CF₄ plasma of the thermal spray coating, and “Pp” representing the plasma power per unit area (W/cm²) applied onto the thermal spray coating.

2. The thermal spray coating according to claim 1, wherein the porosity of the thermal spray coating is no greater than 15%.

3. The thermal spray coating according to claim 1, wherein the thickness of the thermal spray coating is between 50 and 1,000 μm inclusive.

4. The thermal spray coating according to claim 1, wherein the size of the crystallites in the thermal spray coating is between 10 and 50 nm inclusive.

5. The thermal spray coating according to claim 1, wherein the Vickers microhardness of the thermal spray coating is no less than 300.

6. The thermal spray coating according to claim 1, wherein the ratio between the wear volume of the thermal spray coating and the wear volume of carbon steel SS400 when the carbon steel SS400 and the thermal spray coating are subjected to an identical wear test is no greater than 3.

7. A thermal spray coating comprising yttrium oxide at least as a main component, wherein, when the thermal spray coating is exposed to CF₄ plasma and the plasma power of the CF₄ plasma per unit area applied onto the thermal spray coating is less than 0.8 W/cm², an etching rate by the CF₄ plasma of the thermal spray coating satisfies the equation Re≦8.0×Pp^{2.2}, “Re” representing the etching rate (nm/minute) by the CF₄ plasma of the thermal spray coating, and “Pp” representing the plasma power per unit area (W/cm²) applied onto the thermal spray coating.

8. The thermal spray coating according to claim 7, wherein the porosity of the thermal spray coating is no greater than 17%.

9. The thermal spray coating according to claim 7, wherein the thickness of the thermal spray coating is between 50 and 1,000 μm inclusive.

10. The thermal spray coating according to claim 7, wherein the size of the crystallites in the thermal spray coating is between 20 and 80 nm inclusive.

11. The thermal spray coating according to claim 7, wherein the Vickers microhardness of the thermal spray coating is no less than 300.

12. The thermal spray coating according to claim 7, wherein the ratio between the wear volume of the thermal spray coating and the wear volume of carbon steel SS400 when the carbon steel SS400 and the thermal spray coating are subjected to an identical wear test is no greater than 2.5.
